(19) United States
(12) Patent Application Publication
(10) Pub. No.: US 2026/0234366 A1
(43) Pub. Date: Aug. 13, 2026

(54) A SOLID PLASTIC ARTICLE

(71) Applicant: VECOR IP HOLDINGS LIMITED, Kowloon, Hong Kong (CN)

(72) Inventors: Robert R. Ballard, Kowloon, Hong Kong (CN); Ronald Lewarchik, Kowloon, Hong Kong (CN); Charles Wesley Porter, Kowloon, Hong Kong (CN); John Vincent Adap Misa, Clark Freeport Zone, Pampanga (PH); Erwin Noble Fernandez, Kowloon, Hong Kong (CN); Erik Severin, Kowloon, Hong Kong (CN)

(73) Assignee: VECOR IP HOLDINGS LIMITED, Kowloon, Hong Kong (CN)

(21) Appl. No.: 19/156,343

(22) PCT Filed: Feb. 12, 2024
(86) PCT No.: PCT/EP2024/053514

§ 371 Date: Aug. 13, 2025

Related U.S. Application Data
(60) Provisional application No. 63/445,396, filed on Feb. 14, 2023.

(51) Int. Cl. C08K 3/34; C08J 5/18

(52) U.S. Cl. CPC C08K 3/34; C08J 5/18; C08J 2323/06; C08J 2323/12; C08K 2201/005; C08K 2201/014

(57) ABSTRACT

A solid plastic article and a solid plastic concentrate comprising a plastic polymer, titanium dioxide and fly ash. Also, a process of making a solid plastic article by obtaining a solid plastic concentrate, contacting the concentrate with plastic polymer to form a mixture, melting the mixture, and forming and solidifying the molten mixture into the solid plastic article.

### FIELD OF THE INVENTION

The present invention relates to solid plastic articles, methods of making solid plastic articles, and solid plastic concentrates. The solid plastic articles have excellent optical properties and have a good environmental profile.

### BACKGROUND OF THE INVENTION

Plastic polymers, such as polyolefin polymers (including polyethylene and/or polypropylene) do not naturally interact with visible light so are often transparent or translucent. Very many plastic articles made from these plastic polymers, such as those made from polyolefins, therefore also incorporate pigments to provide colour and/or opacity. A high level of opacity/hiding power is important for many plastic articles to ensure a uniform and homogenous appearance to the article even in localised areas where the plastic may be thin. High hiding powder is especially important for opaque films, such as the films, including films used in packaging such as plastic bags.

Titanium dioxide (TiO₂) is a very high performing white pigment. TiO₂ can be blended into plastic articles, and especially articles made from polyolefins, to provide high levels of whiteness and opacity/hiding power. TiO₂ can also provide other benefits, such as resistance to UV-light (hence improved weathering and aging) and durability. However, TiO₂ is expensive and has a low environmental benefit. Producers of plastic articles containing TiO₂ therefore constantly try to find ways to improve the performance of TiO₂ in the plastic article whilst maintaining excellent optical properties as well as the other above-mentioned benefits of TiO₂.

The inventors have discovered that fly ash can be combined with TiO₂ in the presence of plastic polymers, especially polyolefins, to provide a plastic article that has excellent optical properties. The incorporation of the fly ash also can improve robustness of the plastic article and is easy and practical to do in conventional plastic processing equipment and techniques. In addition, the use of fly ash to make plastic articles is environmentally friendly and is a good use of this waste material.

### SUMMARY OF THE INVENTION

The present invention provides a solid plastic article comprising:
(a) from greater than 25 wt % to 98 wt % plastic polymer;
(b) from 1.0 wt % to 55 wt % titanium dioxide; and
(c) from 0.3 wt % to 20 wt % fly ash, wherein the weight ratio of titanium dioxide to fly ash is in the range of from 20:1 to 1:1.

The present invention also provides a process of making the solid plastic article, wherein the process comprises the steps:
(a) obtaining a solid plastic concentrate, wherein the concentrate comprises:
   (i) from greater than 5.0 wt % to 55 wt % plastic polymer;
   (ii) from 30 wt % to 75 wt % titanium dioxide; and
   (iii) from 5.0 wt % to 50 wt % fly ash,
(b) contacting the concentrate with plastic polymer in amounts such that the weight ratio of plastic polymer to concentrate is in the range of from 1:1 to 50:1 to form a mixture;
(c) melting the mixture to form a molten mixture; and
(d) forming and solidifying the molten mixture into a solid plastic article.

The present invention also provides a solid plastic concentrate, wherein the concentrate comprises:
(i) from greater than 5.0 wt % to 55 wt % plastic polymer;
(ii) from 30 wt % to 75 wt % titanium dioxide; and
(iii) from 5.0 wt % to 50 wt % fly ash.

### DETAILED DESCRIPTION OF THE INVENTION

### Solid Plastic Article

The solid plastic article comprises:
(a) from greater than 25 wt % to 98 wt % plastic polymer;
(b) from 1.0 wt % to 55 wt % titanium dioxide; and
(c) from 0.3 wt % to 20 wt % fly ash, wherein the weight ratio of titanium dioxide to fly ash is in the range of from 20:1 to 1:1.

Different amounts of fly ash can be incorporated into the article, and the amounts of the other ingredients can be optimized accordingly. This is especially suitable when the article is in the form of a film.

The article may be in the form of a film and comprise:
(a) from greater than 45 wt % to 98 wt % plastic polymer;
(b) from 1.0 wt % to 15 wt % titanium dioxide; and
(c) from 0.3 wt % to 10.0 wt % fly ash.

Alternatively, the article may be in the form of a film and comprise:
(a) from greater than 30 wt % to 80 wt % plastic polymer;
(b) from greater than 15 wt % to 30 wt % titanium dioxide; and
(c) from 1.5 wt % to 15 wt % fly ash.

Alternatively, the article may be in the form of a film and comprise:
(a) from greater than 25 wt % to 65 wt % plastic polymer;
(b) from greater than 30 wt % to 55 wt % titanium dioxide; and
(c) from 3 wt % to 20 wt % fly ash.

Alternatively, the article may be in the form of a film and comprise:
(a) from greater than 60 wt % to 98 wt % plastic polymer;
(b) from 1.0 wt % to 8.0 wt % titanium dioxide; and
(c) from 0.3 wt % to 3.0 wt % fly ash.

When the article is in the form of a film, including for example any of the above-described films, it may be preferred to control the melt flow of the polyolefin. This can be especially suitable when the polyolefin is polyethylene. The article may be in the form of a film and the polyolefin may have a melt flow index of less than 5.0, or less than 4.5, or less than 4.0, or less than 3.5, or less than 3.0, or from 0.01 to 5.0, or from 0.01 to 4.0, or from 0.01 to 3.0, or from 0.01 to 2.0.

Preferably, the amount of water present in the article is minimised. Preferably, the article has a moisture content of less than 5.0 wt %, or less than 4.0 wt %, or less than 3.0 wt %, or less than 2.0 wt %, or less than 1.0 wt %.

The surface of the article may be treated. Suitable surface treatments include corona treatments to make the surface hydrophilic. This can make the surface of the article easier to print on.

However, the surface of the article may be untreated.

The article may be in the form of an extruded pipe or extruded profile or any object or shape comprising plastic and capable of being formed into the desired shape, typically by one or more of extrusion including blown extrusion and cast extrusion, casting, calendering, blow molding, injection molding, vacuum forming, pressure forming, compression molding, transfer molding and combinations thereof.

### Plastic Polymer

Suitable plastic polymers include styrene polymers and copolymers such as polystyrene (PS), styrene butadiene and acrylonitrile butadiene styrene (ABS), vinyl polymers and copolymers including poly(vinyl chloride) (PVC), poly(vinyl fluoride), vinylidene chloride/vinyl chloride copolymer, and the like, including blends, polycarbonates (PC) and PC blends, polyamides (PA), terephthalate polymers including polybutylene terephthalate (PBT), polyethylene terephthalate (PET), polyphenylene ether (PPE), polyphenylene sulphide (PPS), polysulphone (PES) and acrylate and methacrylate-based polymers including PMA and PMMA. Polyolefins are especially suitable.

Manufacturers of suitable plastic polymers include Dow Chemical, Lyondell Basell, BASF, ENI, LG Chemical, ExxonMobil, Ineos, Sabic, Formosa Plastics Group, Chevron Phillips, Lanxess, Arkema, Borouge, Eastman, Hanwha, Mitsui Chemicals, Reliance, Polyone, Sinopec, Total, UBE Industries, Sasol and Sumitomo and many others.

Suitable plastic polymers are selected from polyolefin, terephthalate polymer, polycarbonate, polystyrene, and polyvinyl chloride.

### Polyolefin

Any suitable polyolefin may be used.

A preferred polyolefin is selected from polyethylene, polypropylene and/or polybutylene. A preferred polyolefin is selected from polyethylene and/or polypropylene. Preferably, the polyolefin is polyethylene.

Plastic articles comprising polyolefin polymer, and especially polyethylene and/or polypropylene can be made by the following processes: blow molding; blown film; cast film; extrusion coating; high temperature cast film; and injection molding. These plastic articles can be used in packaging. The plastic articles can be used in other applications.

Polyolefins having a lower melt flow index may be preferred for blown film processing. Polyolefins having a higher melt flow index may be preferred for cast film extrusion.

Suitable polyolefins are based on the polymerization of short chain olefins such as ethene/ethylene and propene/propylene. Such polymers are referred to as polyolefins.

Examples of suitable polyolefins include polyethylene (PE) and polypropylene (PP). As polymeric materials, there is an almost limitless number of possible polymeric variations depending on the nature of the catalyst used in the polymerisation and how the material has been polymerised. There are many variations of such polymer resins commercially available, for example varying in molecular weight, degree of branching and nature and level of any copolymers. For example, polypropylene can be co-polymerised with ethylene to improve mechanical toughness and polyolefins can also be blended with elastomers to change physical properties.

Types of polyethylene include LDPE (Low Density Polyethylene), HDPE (High Density Polyethylene) and LLDPE (Linear LDPE) and blends thereof.

There are three general types of polypropylenes: homopolymer; random copolymer; and block copolymer. Typically, polypropylene is less resistant to chemical degradation than polyethylene.

Different polyolefins can be blended to provide specific properties. For example, metallocene catalyzed polyethylenes (mPE) tend to have narrow molecular weight distributions and low levels of branching They are typically more difficult to process than low-density polyethylenes (LDPE) and require more motor power and higher extruder pressures compared to LDPEs as well as having lower melt strengths. However, they typically exhibit superior physical properties as compared to LDPEs. LDPE can be blended with mPE to increase melt strength, to increase shear sensitivity, i.e., to increase flow at commercial shear rates in extruders; and to reduce the tendency to melt fracture.

Manufacturers of suitable polyolefin resins include Dow Chemical, Lyondell Basell, BASF, ENI, LG Chemical, ExxonMobil, Ineos, Sabic, Formosa Plastics Group and many others.

Examples of suitable polyolefin resins include the AGILITY and DOW ranges of LDPE resins, the AFFINITY range from Dow Chemical, the ENABLE™, EXACT™, EXCEED™, ESCORENE™, EXXCO™, ESCOR™, PAXON™, and OPTEMA™ ranges from Exxon Mobil.

### Terephthalate Polymer

A suitable terephthalate polymer includes polybutylene terephthalate (PBT) and polyethylene terephthalate (PET).

### Polystyrene

Suitable polystyrene includes acrylonitrile butadiene styrene (ABS), polystyrene (PS) and high impact polystyrene (HIPS).

### Polyvinyl Chloride

Plastic articles comprising polyvinyl chloride can be used for construction applications.

### Other Plastic Polymers

Other suitable plastic polymers include polyamide (PA), polyphenylene ether (PPE), polyphenylene sulphide (PPS), polysulphone (PES), acrylics (PMA and PMMA) and composites (e.g., EP and UP resin-based materials).

### Titanium Dioxide

Any suitable titanium dioxide can be used.

TiO₂ has a number of polymorphs, typically the pigment particles are either anatase or rutile. Many TiO₂ pigments are surface modified to optimise specific aspects of their performance. For example, TiO₂ pigments can be treated to make the surface more hydrophobic to ensure compatibility in plastics. Suitable TiO₂ pigments include the Ti-Pure range, such as Ti-Pure R906, and the Tioxide range from Venator.

The titanium dioxide can be selected from type 1 plastic titanium dioxide, type 2 plastic titanium dioxide and/or type 3 plastic titanium dioxide.

### Fly Ash

Preferably, the fly ash has a d₅₀ particle size of less than 4.0 μm, preferably less than 3.5 μm, or preferably less than 3.0 μm, and preferably in the range of from 0.5 μm to 3.0 μm, or from 1.0 μm to 2.0 μm.

Preferably, the fly ash has a doo of less than 12 μm, or less than 10 μm, or less than 8.0 μm, or less than 6.0 μm, or less than 5.0 μm, or less than 4.0 μm.

A narrow particle size distribution is preferable.

Fly ash having a d₅₀ of less than 4.0 μm and a d₅₀ in the range of from 1.0 μm to 2.0 μm is particularly preferable.

Preferably, the fly ash has a d₁₀ of from 0.1 μm to 1.5 μm, or from 0.2 μm to 1.0 μm, or from 0.3 μm to 0.8 μm, or from 0.4 μm to 0.6 μm.

The particle size of the fly ash can be controlled by milling. A preferred approach is to co-mill the fly ash, typically treated fly ash, and TiO₂ before forming the blend into a concentrate prior to forming the inventive plastic article.

A highly preferred fly ash is a milled fly ash.

Preferably the fly ash is treated before addition into the plastic article. Suitable treatments include magnetic extraction, washing (including acid-washing), milling and calcination. Calcination can be used to reduce residual carbon levels in the fly ash and/or promote other useful phase transformations, such as the formation of preferred mineral phases. Calcination is useful to ensure a more consistent product for use. It also typically improves fly ash colour. Typically, calcination is also useful as it obviously inherently eliminates water in the fly ash.

The washing steps can include chemical treatment, such as treatment with acids. Such treatments can be used to improve the surface compatibility of the fly ash and assist dispersion of the fly ash into the polyolefin. It can also be used to reduce iron oxide levels to improve colour. Milling is typically required after any calcination step as fly ash particles can sinter together during calcination and form large unwanted aggregates.

Typically, the fly ash is acid treated. A preferred beneficiation process for fly ash uses acid-treatment of the fly ash. A preferred fly ash is acid treated and milled (can be simultaneously or sequentially). The acid treatment can remove alkaline species such as calcium oxide, other metal species such as iron salts and may also leave a roughened surface. Without wishing to be bound by theory, it is believed that particles with rough or irregular surfaces have surface pores which help to trap and better hold TiO₂ particles in place, thus counteracting their tendency to aggregate. The acid-treatment can also reduce the level of iron (and other metal) species in the fly ash. The iron, and other metal species present in the fly ash can result in fly ash having a darker colour.

Suitable treatments of the fly ash include surface treatments. Typically, these include treatments to make the surface of the fly ash more hydrophobic and easier to disperse into a (inherently hydrophobic) polyolefin. Suitable surface treatments include silanisation or coating with a hydrophobic coating material, for example stearic acid.

Preferably, the fly ash has an oil adsorption of less than 40 cc/100 g, or less than 35 cc/100 g, or in the range of from 1 to 35 cc/100 g, or from 10 cc/100 g to 30 cc/100 g. A further benefit of using fly ash, as compared to other possible materials, is that fly ash typically has a low oil adsorption value. The oil adsorption value relates to the porosity of a powder and its ability to adsorb liquid. The addition of an adsorbent material to a molten polymer mix can obviously have an effect on the rheology of the mix. This can limit the amount of particulate additive that can be added to a molten mix if the required rheology is to be maintained. Control of rheology is important for processing, for example blown extrusion. The use of inherently low absorbency fly ash is believed to allow higher levels of fly ash to be added without issue.

Preferably, the fly ash comprises less than 1.5 wt %, or less than 1.0 wt %, or less than 0.5 wt % Fe₂O₃.

Preferably, the fly ash comprises less than 1.5 wt %, or less than 1.0 wt %, or less than 0.5 wt % CaO.

Typically, the fly ash has an iron oxide content of less than 1.5 wt % or less than 1.0 wt %, or even less than 0.5 wt %.

Preferably, the fly ash is coal combustion fly ash, most preferably pulverised coal combustion (PCC) fly ash. The fly ash can be Type F coal fly ash.

Preferably, the amount of carbon content in the fly ash us minimized. Preferably, the fly ash comprises less than 5.0 wt %, or less than 4.0 wt %, or less than 3.0 wt %, or less than 2.0 wt %, or less than 1.0 wt %, or even less than 0.5 wt % carbon content.

Preferably, the amount of water present in the fly ash is minimised. Preferably, the fly ash has a moisture content of less than 4.0 wt %, or less than 3.0 wt %, or less than 2.0 wt %, or less than 1.0 wt %, or less than 0.5 wt %. Preferably the amount of water in the mix prior to forming the article is less than 5% or 4% or 3% or 2% or even 1%. The presence of water in the fly ash, and/or in the composition generally forming the article is not preferred due to the formation of steam during melt extrusion processing which can cause surface imperfections and defects. Desiccants such as calcium oxide can be added to the composition mix at low levels to deal with water present and avoid the formation of surface defects. Use of very dry fly ash is believed to aid the dispersion of the fly ash in the molten plastic mix. It is believed that the avoidance of moisture on the surface of the fly ash minimises hydrophilicity and increases compatibility with the hydrophobic polymer mix.

Preferably, the fly ash has an oil adsorption of less than 40 cc/100 g, or less than 35 cc/100 g, or in the range of from 1 to 35 cc/100 g, or from 10 cc/100 g to 30 cc/100 g, or from 20 cc/100 g to 40 cc/100 g, or even from 20 cc/100 g to 30 cc/100 g.

Preferably, the fly ash has a zeta potential in the range of from −20 mV to −60 mV. Typically, the zeta potential is measured at a pH of 7.0, and at a solids concentration of 0.1 wt % in a 0.01M NaCl aqueous solution.

### Other Ingredients

The article may comprise other ingredients. Suitable ingredients include fillers and coloured pigments. The additives may be added during formation of the plastic article or may be already incorporated as a pre-mix with the plastic polymer.

Suitable additives include:
Antioxidants including primary antioxidants such as BHT and other radical scavengers, secondary antioxidants such as phosphite esters and thioesters and antiozonants and phenolic antioxidants;
Nucleating agents such as phosphate esters and talc;
Acid scavengers such as calcium stearate, zinc stearate, zinc oxide and hydrotalcite; stabilizers;
Anticorrosion agents such as volatile corrosion inhibitors;
Plasticizers;
Blowing agents including azodicarbonamide (ADC) and 4,4-oxybis(benzenesulfonyl hydrazide) (OBSH);
Cavitating agents such as polybutylene terephthalate;
Surfactants including anionic surfactants such as alkali metal alkyl sulfonates and nonionic surfactants such as Span 80;
Slip additives such as erucamide and/or oleamide;
Antistatic agents such as Glycerol monostearate (GMS); ethoxylated fatty acid amines; and/or diethanolamides;
Tackifying agents such as polyisobutylene (PIB);
UV and light absorbers/stabilisers such as benzotriazoles, benzophenones, organic nickel salts and/or hindered amine light stabilisers;
Lubricants such as waxes and/or soap; and/or
Curing agents such as organic peroxides.

In particular, antioxidants and stabilizers such as organic phosphites, hindered amines, and/or phenolic antioxidants may be present in the plastic article al levels from 0.001 wt % to 2.0 wt %.

### Filler

The article may comprise a filler. Any suitable filler may be used. The article may comprise from 10 wt % to 60 wt % filler.

Suitable fillers can be mineral fillers, which include calcium carbonate, talc, sodium sulfate, calcium sulfate, calcium silicate, silicon carbide, silica (and other oxides of silica, precipitated or not), antimony oxide, lead carbonate, zinc white, lithopone, zircon, corundum, spinel, apatite, barium sulfate, magnesite and dolomite.

Suitable fillers can be organic fillers, which include sawdust, milled rice husks, milled chicken feathers and milled nut shells.

A combination of mineral filler and organic filler may be present.

Fillers can be selected based on the application and desired changes in properties, but the main advantage provided by fillers is the reduction in cost provided by the low cost of such fillers and the high proportion that they can be blended into the polyolefin.

Such fillers can be added to the mix forming the plastic article in the form of highly concentrated concentrates or can be blended directly with the plastic polymer and/or other components.

Preferably, the filler is selected from calcium carbonate, calcium sulphate, calcium silicate, talc, mica, clay, and any combination thereof.

The article may comprise from 10 wt % to 60 wt % filler selected from calcium carbonate, calcium sulphate, calcium silicate, talc, mica, clay, and any combination thereof.

Coloured Pigment and/or Dye

The article may further comprise a coloured pigment and/or dye. This can be preferred if a non-white colour is desired. Suitable dyes and/or pigments may be organic or inorganic. Inorganic pigments are typically used in applications where opacity is needed. Organic dyes/pigments include polycyclic dyes such as the anthraquinones, azo dyes and metal complex dyes. Many suitable coloured pigment and/or dyes may be used in combination with the TiO₂ and fly ash.

### Process of Making the Solid Plastic Article

The process comprises the steps:
(a) obtaining a solid plastic concentrate, wherein the concentrate comprises:
   (i) from greater than 5.0 wt % to 55 wt % plastic polymer;
   (ii) from 30 wt % to 75 wt % titanium dioxide; and
   (iii) from 5.0 wt % to 50 wt % fly ash,
(b) contacting the concentrate with plastic polymer in amounts such that the weight ratio of plastic polymer to concentrate is in the range of from 1:1 to 50:1 to form a mixture;
(c) melting the mixture to form a molten mixture; and
(d) forming and solidifying the molten mixture into a solid plastic article.

### Step (a)

Step (a) obtains a solid plastic concentrate, wherein the concentrate comprises:
(i) from greater than 5.0 wt % to 55 wt % plastic polymer;
(ii) from 30 wt % to 75 wt % titanium dioxide; and
(iii) from 5.0 wt % to 50 wt % fly ash.

Step (a) can be a high-pressure extrusion step, such as in a twin-screw extruder.

Step (a) can be carried out at an elevated temperature, such as above ambient temperature. The TiO₂ and fly ash will typically be intensely sheared at elevated temperature to ensure good dispersion in the plastic polymer prior to extrusion. The molten mixture that is typically formed can be cooled and cut to form extrudates of the plastic concentrate. Such concentrate can be referred to as masterbatches.

Suitable mixers for step (a) include any high shear mixer able to heat and melt polymer resins and disperse the other additives. These include continuous mixers such as extruders, including Single, Twin and Multi-Screw Extruders or batch mixers, such as Banbury-type mixers. Suitable extruders include the ZSK series from Coperion GmbH. Suitable batch mixers include the CB200 mixer from Carter Ltd, of Rochdale, UK. Mixers need to be able to be selectively heated or cooled to be able to maintain desired temperatures at specific points in the process.

### Step (b)

Step (b) contacts the concentrate with plastic polymer in amounts such that the weight ratio of plastic polymer to concentrate is in the range of from 1:1 to 50:1 to form a mixture.

Step (b) can be done by feeding the various ingredients at defined rates using multiple individual feeders into a feed hopper located above an extruder inlet. The mixture of ingredients may then be fed at a controlled rate from the feed hopper into the inlet of the extruder. Dosing feeders can be volumetric feeders or preferably loss-in-weight feeders such as those supplied by Brabender or K-Tron. Step (b) can happen in heated batch mixers, but preferably is done continuously.

An extruder set-up for plastic extrusion may consist of a feed hopper, a barrel capable of being heated or cooled along its length, one or more rotating screws, a screen and screen changer and a die adapter. Suitable extruders include single screw and twin-screw extruders. Twin-screw extruders can be co-rotating or counter-rotating. Some twin screw extruders allow additives to be add to the mix at different stages along the barrel. Suitable extruders for plastic extrusion include the single screw extruder range made by Boston Matthews Ltd of Worcester, UK and the ZSK range of twin-screw extruders made by Coperion GmbH. Twin screw extruders are typically capable of generating more intense shear and mixing and higher pressures than single flight extruders. Typical extruder speeds are 80-150 rpm. The screw profile in a plastic extruder will have a feed zone, a melting zone and the metering zone just prior to the die-plate with different screw profiles.

Other ingredients, if present, may be incorporated into the mixture formed in step (b).

### Step (c)

Step (c) melts the mixture to form a molten mixture.

Preferably, step (c) is carried out in an extruder. The temperature profile of the barrel of the extruder can be controlled to ensure that the temperature increases along the barrel of the extruder such that mixture is melted in the extruder but that the temperature does not get too high. Temperatures in the feed zone can be from 40° C. to 50° C. and increase towards the die-plate. The mixing and shear in the extruder can generate very significant frictional heat and this viscous heating can be enough to maintain high temperatures in some mixes and even require the use of cooling. The barrel can be heated or cooled as required. Temperatures in an extruder can range from 160° C. to over 250° C. depending on the plastic resin. For example, parts of the extruder may need to be cooled by blowing air around sections of the barrel to provide cooling. Some extruders have additional cooling within the shaft(s) of the extruder. If the mix becomes too hot, the viscosity of the mix can become too low. When this happens, the rotational action of the shaft(s) cannot generate enough pressure due to back-slip to force the molten mixture through the die-plate. Very often the molten plastic is forced through a screen to remove solid contaminants and homogenise the mix. The molten plastic is sometimes fed to a pump arrangement which help generate a very uniform flowrate when used for film extrusion.

Long, properly designed screw(s) makes for better melting and mixing of the resin, as well as better film appearance, closer gauge tolerance and increased production rate. Screws are specified by their length to-diameter (L/D) ratio and compression ratio. Ideally, the screw should be at least 24 times, preferably 28 to 30 times, as long as its diameter. A larger L/D ratio allows enhanced mixing. The compression ratio is the ratio of the channel volume of one screw flight in the feed section to that of one screw flight in the metering section. Thus, a typical screw for polyolefin film extrusion should have a 24:1 to 30:1 L/D ratio and a 2.5 to 3.51 compression ratio.

Extruder screws can have internal water cooling. A cool screw can improve resin mixing, but usually reduces output at a given screw speed. If a screw overheats, it loses much of its pumping capacity.

### Step (d)

Step (d) forms and solidifies the molten mixture into the solid plastic article.

Typically, the molten mixture is forced through a die to form it into the desired profile and then cooled to solidify the molten mixture to form the solid plastic article.

When forming a film, the molten mixture can be forced through a narrow slit in a die. The slit may be either a straight line or a circle. The resulting film has either the form of a sheet (cast film) or a tube, also called a “bubble” (blown film). As the film comes out of the die, it can be cooled and then rolled up on a core.

Step (d) may be a blown extrusion step; this is especially suitable then the article is in the form of a film. In blown extrusion, the molten mixture can be cooled by air jets. This is typically due to the thinness of the film.

Step (d) may be a cast extrusion step; this is especially suitable then the article is in the form of a film. The molten mixture can be cooled by being contacted onto chilled rollers.

Step (d) may be an injection molding step.

Step (d) may be a rotary molding step.

In any molding process, the die may have some cooling mechanism to help solidify the molten mixture.

Step (d) may be a continuous extruded step. This is especially suitable when extruding plastic articles such as pipes or profiles shapes, such as window edges. Typically, the extruded plastic article is cooled in a water bath under controlled conditions.

### Plastic Concentrate

The solid plastic concentrate comprises:
(i) from greater than 5.0 wt % to 55 wt % plastic polymer;
(ii) from 30 wt % to 75 wt % titanium dioxide; and
(iii) from 5.0 wt % to 50 wt % fly ash.

The solid plastic concentrate is suitable for use in the process of making the solid plastic article. The solid plastic concentrate is typically added to the plastic polymer and diluted during the process of making the solid plastic article.

### Method of Measuring Particle Size Distribution

The particle size distribution is typically measured by laser diffraction. A suitable standard for size analysis by laser diffraction is given in ISO 13320:2009. Suitable size analysers are the Mastersizer® 2000 and 3000 instruments by Malvern Instruments®. It is preferred to disperse the samples by compressed air (usually with a Scirocco 2000® unit) where the material is tested as a powder stream, rather than the wet method where the test material is dispersed in a fluid first. However, it is possible to disperse and test these mixtures in non-aqueous liquids. The measurement is typically done as per the manufacturer's instruction manual and test procedures. The results are typically expressed in accordance with ISO 9276-2.

### Method of Measuring Melt Flow Index

Melt Flow Index of polyethylenes and polyethylene-based mixes is measured according to ASTM D1238-20 at 190° C., under a load of 2.16 kg. The Melt Flow Index of polypropylenes and polypropylene-based mixes, and most other polymers, is measured according to ASTM D1238 at 230° C., under a load of 2.16 kg. The units for MFI are g/10 min. About 5 g of the test sample is packed into a heated ram extruder having an orifice 2 mm wide and 8 mm long. The sample is pre-heated and then the force is applied. This forces the molten polymer through the die. The amount passing through the die once the flow is steady is collected over a fixed period and calculated as grams per 10 mins. Suitable equipment is the Haake MeltFlow ST.

### Method of Measuring Moisture Level

The level of moisture of any additive or resin is measured by heating 2.00 g of material spread out on a metal pan to 100° C. for 1 hour to dry the sample. The sample is then cooled and weighed. The moisture content is given by the % weight loss of the sample.

### Method of Measuring Carbon Content

The level of combustible carbon is measured by the Loss on Ignition (LOI) test as per ASTM D7348. In this test, 1 g of fly ash is first dried at 150° C. to dry the sample. The sample is then cooled and weighed. Then the sample is heated in a step wise manner over a two-hour period to reach 500° C.

### Method of Measuring Oil Adsorption

The oil absorption can be measured according to ASTM D-281-12. The test sample size is 20 g. Linseed oil is added dropwise to 20 g of the material to be tested and mixed with a spatula until a smooth paste is formed that can be spread uniformly over a flat surface. Values are reported as cc of oil needed to first form a paste per 100 g of powder.

### Method of Measuring Iron Oxide Content

The level of iron oxide is typically measured by X-ray fluorescence. The typical particle size of the fly ash is sufficiently small that the technique is suitable for accurate measurement. The technique works by the excitation of the sample using high energy gamma or X-rays. This causes an ionisation of the atoms present which then emit characteristic frequency EM radiation which is dependent on the type of atom. Analysis of the intensity of different frequencies allows an elemental analysis to be made. Suitable equipment would be the Varta range of XRF analyzers supplied by Olympus. The equipment detects elemental iron and the result is most usually converted to the corresponding level of Fe₂O₃.

### Method of Measuring Calcium Oxide Content

Calcium oxide levels can be measured by X-Ray Fluorescence as described in ASTM D4326-21 “Standard Test Method for Major and Minor Elements in Coal Ash by X-Ray Fluoresence”. Suitable XRF equipment includes the Epsilon 4 XRF analyser from Malvern Panalytical using sample disks prepared using an Aegon 2 automatic fusion equipment for sample disk preparation from Claisse. The ash sample is automatically dissolved in molten lithium borate flux and formed into a disk. This is then placed in the Epsilon 4 for analysis. Equipment should be operated as per manufacturer's instructions. When measuring for CaO, the Epsilon 4 should be set to a voltage of 12 kV, a current of 25 μa, not use helium as the medium, use a 50μ Al filter, and have a measurement time of 450 s.

### Method of Measuring Zeta Potential

Suitable equipment for measuring the zeta potential of a material is the Zetasizer range from Malvern Panalytical, such as the Zetasizer Lab from the Zetasizer Advance range.

Equipment should be operated as per the manufacturer's instructions. It is important to have sample concentrations that are not too high or low as this can cause attenuation of the beam. Concentrations of 0.1% (1 g sample in 1 litre solution) are suitable for most materials of interest here. A solution of NaCl can also be used and concentrations of 0.01M at a pH of 7 are suitable. Measurements should be made at ambient temperature conditions.

### Embodiments of the Present Invention

1. A solid plastic article comprising:
(a) from greater than 25 wt % to 98 wt % plastic polymer;
(b) from 1.0 wt % to 55 wt % titanium dioxide; and
(c) from 0.3 wt % to 20 wt % fly ash,
wherein the weight ratio of titanium dioxide to fly ash is in the range of from 20:1 to 1:1.

2. An article according to embodiment 1, wherein the article is in the form of a film and comprises:
(a) from greater than 45 wt % to 98 wt % plastic polymer;
(b) from 1.0 wt % to 15 wt % titanium dioxide; and
(c) from 0.3 wt % to 10.0 wt % fly ash.

3. An article according to embodiment 1, wherein the article is in the form of a film and comprises:
(a) from greater than 30 wt % to 80 wt % plastic polymer;
(b) from greater than 15 wt % to 30 wt % titanium dioxide; and
(c) from 1.5 wt % to 15 wt % fly ash.

4. An article according to embodiment 1, wherein the article is in the form of a film and comprises:
(a) from greater than 25 wt % to 65 wt % plastic polymer;
(b) from greater than 30 wt % to 55 wt % titanium dioxide; and
(c) from 3 wt % to 20 wt % fly ash.

5. An article according to embodiment 1, wherein the article is in the form of a film and comprises:
(a) from greater than 60 wt % to 98 wt % plastic polymer;
(b) from 1.0 wt % to 8.0 wt % titanium dioxide; and
(c) from 0.3 wt % to 3.0 wt % fly ash.

6. An article according to any preceding embodiment, wherein the plastic polymer is selected from polyolefin, terephthalate polymer, polycarbonate, polystyrene, and polyvinyl chloride.

7. An article according to any preceding embodiment, wherein the plastic polymer is a polyolefin selected from polypropylene and/or polyethylene.

8. An article according to any preceding embodiment, wherein the article is in the form of a film and wherein the plastic polymer has a melt flow index of less than 5.0.

9. An article according to any of embodiments 1 and 6-8, wherein the solid plastic article comprises from 10 wt % to 60 wt % filler selected from calcium carbonate, calcium sulphate, calcium silicate, talc, mica, clay, and any combination thereof.

10. An article according to any preceding embodiment, wherein the titanium dioxide is selected from type 1 plastic titanium dioxide, type 2 plastic titanium dioxide and/or type 3 plastic titanium dioxide.

11. An article according to any preceding embodiment, wherein the fly ash comprises less than 1.5 wt % carbon content.

12. An article according to any preceding embodiment, wherein the fly ash has a particle size distribution such that the d₅₀ is in the range of from 0.1 μm to 4.0 μm.

13. An article according to any preceding embodiment, wherein the article has a moisture content of less than 2.0 wt %.

14. An article according to any preceding embodiment, wherein the article further comprises an ingredient selected from: coloured pigment; coloured dye; plasticizer; UV-stabilizer; anti-block agent; anti-oxidant; lubricant; and any combination thereof.

15. An article according to any preceding embodiment, wherein the article forms a layer of a laminated film.

16. A process of making a solid plastic article according to any of embodiments 1-15 wherein the process comprises the steps:
(a) obtaining a solid plastic concentrate, wherein the concentrate comprises:
   (i) from greater than 5.0 wt % to 55 wt % plastic polymer;
   (ii) from 30 wt % to 75 wt % titanium dioxide; and
   (iii) from 5.0 wt % to 50 wt % fly ash,
(b) contacting the concentrate with plastic polymer in amounts such that the weight ratio of plastic polymer to concentrate is in the range of from 1:1 to 50:1 to form a mixture;
(c) melting the mixture to form a molten mixture; and
(d) forming and solidifying the molten mixture into a solid plastic article.

17. A process according to embodiment 16, wherein step (d) is selected from: a blown extrusion step; a cast extrusion step; an injection molding step; a rotary molding step; and/or a continuous extruded step.

18. A solid plastic concentrate, wherein the concentrate comprises:
(i) from greater than 5.0 wt % to 55 wt % plastic polymer;
(ii) from 30 wt % to 75 wt % titanium dioxide; and
(iii) from 5.0 wt % to 50 wt % fly ash.

19. A concentrate according to embodiment 18, wherein the plastic polymer is selected from polyolefin, terephthalate polymer, polycarbonate, polystyrene, and polyvinyl chloride.

20. A concentrate according to any of embodiments 18-19, wherein the plastic polymer is a polyolefin selected from polypropylene and polyethylene.

21. A solid plastic article comprising:
(a) from greater than 25 wt % to 98 wt % polyolefin;
(b) from 1.0 wt % to 55 wt % titanium dioxide; and
(c) from 0.3 wt % to 20 wt % fly ash,
wherein the weight ratio of titanium dioxide to fly ash is in the range of from 20:1 to 1:1.

22. An article according to embodiment 21, wherein the article is in the form of a film and comprises:
(a) from greater than 45 wt % to 98 wt % polyolefin;
(b) from 1.0 wt % to 15 wt % titanium dioxide; and
(c) from 0.3 wt % to 10.0 wt % fly ash.

23. An article according to embodiment 21, wherein the article is in the form of a film and comprises:
(a) from greater than 30 wt % to 80 wt % polyolefin;
(b) from greater than 15 wt % to 30 wt % titanium dioxide; and
(c) from 1.5 wt % to 15 wt % fly ash.

24. An article according to embodiment 21, wherein the article is in the form of a film and comprises:
(a) from greater than 25 wt % to 65 wt % polyolefin;
(b) from greater than 30 wt % to 55 wt % titanium dioxide; and
(c) from 3 wt % to 20 wt % fly ash.

25. An article according to embodiment 21, wherein the article is in the form of a film and comprises:
(a) from greater than 60 wt % to 98 wt % polyolefin;
(b) from 1.0 wt % to 8.0 wt % titanium dioxide; and
(c) from 0.3 wt % to 3.0 wt % fly ash.

26. An article according to any of embodiments 21-25, claim, wherein the polyolefin is selected from polypropylene and polyethylene.

27. An article according to any of embodiments 21-26, claim, wherein the polyolefin is polyethylene.

28. An article according to any of embodiments 21-27, wherein the article is in the form of a film and wherein the polyolefin has a melt flow index of less than 5.0.

29. An article according to embodiments 21 and 26-28, wherein the solid plastic article comprises from 10 wt % to 60 wt % filler selected from calcium carbonate, calcium sulphate, calcium silicate, talc, mica, clay, and any combination thereof.

30. An article according to any of embodiments 21-29, wherein the titanium dioxide is selected from type 1 plastic titanium dioxide, type 2 plastic titanium dioxide and/or type 3 plastic titanium dioxide.

31. An article according to any of embodiments 21-30, wherein the fly ash comprises less than 1.5 wt % carbon content.

32. An article according to any of embodiments 21-31, wherein the fly ash has a particle size distribution such that the d₅₀ is in the range of from 0.1 μm to 4.0 μm.

33. An article according to any of embodiments 21-32, wherein the article has a moisture content of less than 2.0 wt %.

34. An article according to any of embodiments 21-33, wherein the article further comprises an ingredient selected from: coloured pigment; coloured dye; plasticizer; UV-stabilizer; anti-block agent; anti-oxidant; lubricant; and any combination thereof.

35. An article according to any of embodiments 21-34, wherein the article forms a layer of a laminated film.

36. A process of making a solid plastic article according to any of embodiments 21-35 wherein the process comprises the steps:
(a) obtaining a solid plastic concentrate, wherein the concentrate comprises:
   (i) from greater than 5.0 wt % to 55 wt % plastic polymer;
   (ii) from 30 wt % to 75 wt % titanium dioxide; and
   (iii) from 5.0 wt % to 50 wt % fly ash,
(b) contacting the concentrate with plastic polymer in amounts such that the weight ratio of plastic polymer to concentrate is in the range of from 1:1 to 50:1 to form a mixture;
(c) melting the mixture to form a molten mixture; and
(d) forming and solidifying the molten mixture into a solid plastic article.

37. A process according to embodiment 36, wherein step (d) is selected from: a blown extrusion step; a cast extrusion step; an injection molding step; a rotary molding step; and/or a continuous extruded step.

38. A solid plastic concentrate, wherein the concentrate comprises:
(i) from greater than 5.0 wt % to 55 wt % polyolefin;
(ii) from 30 wt % to 75 wt % titanium dioxide; and
(iii) from 5.0 wt % to 50 wt % fly ash.

39. A concentrate according to embodiment 38, wherein the polyolefin is selected from polypropylene and/or polyethylene.

40. A concentrate according to any of embodiments 38-39, wherein the polyolefin is polyethylene.

### EXAMPLES

A range of plastic article concentrates were prepared by compounding 70% additive with 30% of a LLDPE resin having a MFI of 20 in a twin-screw extruder.

| MATERIALS | Example 1 | Example 2 |
|---|---|---|
| COMPOUND FORMULA | | |
| LLDPE Resin [wt | 30% | 30% |
| %] MFI 20 | | |
| TiO2 [wt %] | 40% | 40% |
| Fly ash [wt %] | 30% | |
| Surface Treated | | 30% |
| (0.6% stearic acid) | | |
| Fly Ash | | |
| Fly Ash d50 | 1.91 | 1.91 |
| [micron] | | |
| TiO2 d50 [micron] | 0.3 | 0.3 |
| Resin Type | LLDPE | LLDPE |
| Resin Melt Flow | 20 | 20 |
| Index [MFI] | | |
| COMPOUNDING | | |
| Extruder Temp start | 75 | 75 |
| [F.] | | |
| Extruder Temp at | 350 | 350 |
| Die [F.] | | |
| Maximum Extruder | 350 | 350 |
| Temp [F.] | | |
| Extruder Screw | 240 | 240 |
| [RPM] | | |
| Extruder Pressure at | 425 | 725 |
| the screen [psi] | | |
| Screen | 100 / 150 | 100 / 150 |
| (mesh/micron) | | |

The Fly Ash had a water level of less than 0.2% and a carbon level of under 0.4%. The concentrate extrudates were cooled and cut.

Varying amounts of LDPE resin having a MFI of 2, TiO2 and fly ash were blended and melt extruded and blown in a single screw extruder to form the series of plastic articles being 36 micron thick films having the following compositions and properties. The film bubble diameter was 8 inches, and the production rate was 60 ft/min at a maximum temperature of 400° F. (204.4° C.).

| | Example 3 | Example 4 | Example 5 | Example 6 |
|---|---|---|---|---|
| Total PE Resin | 93 | 93 | 93 | 93 |
| wt % | | | | |
| TiO₂ Level wt % | 5.6 | 4.9 | 4.2 | 3.5 |
| Fly Ash wt % | 1.4 | 2.1 | 2.8 | 3.5 |

1. A solid plastic article comprising:
(a) from greater than 25 wt % to 98 wt % plastic polymer;
(b) from 1.0 wt % to 55 wt % titanium dioxide; and
(c) from 0.3 wt % to 20 wt % fly ash,
wherein the weight ratio of titanium dioxide to fly ash is in the range of from 20:1 to 1:1.

2. An article according to claim 1, wherein the article is in the form of a film and comprises:
(a) from greater than 45 wt % to 98 wt % plastic polymer;
(b) from 1.0 wt % to 15 wt % titanium dioxide; and
(c) from 0.3 wt % to 10.0 wt % fly ash.

3. An article according to claim 1, wherein the article is in the form of a film and comprises:
(a) from greater than 30 wt % to 80 wt % plastic polymer;
(b) from greater than 15 wt % to 30 wt % titanium dioxide; and
(c) from 1.5 wt % to 15 wt % fly ash.

4. An article according to claim 1, wherein the article is in the form of a film and comprises:
(a) from greater than 25 wt % to 65 wt % plastic polymer;
(b) from greater than 30 wt % to 55 wt % titanium dioxide; and
(c) from 3 wt % to 20 wt % fly ash.

5. An article according to claim 1, wherein the article is in the form of a film and comprises:
(a) from greater than 60 wt % to 98 wt % plastic polymer;
(b) from 1.0 wt % to 8.0 wt % titanium dioxide; and
(c) from 0.3 wt % to 3.0 wt % fly ash.

6. An article according to claim 1, wherein the plastic polymer is selected from polyolefin, terephthalate polymer, polycarbonate, polystyrene, and polyvinyl chloride.

7. An article according to claim 1, wherein the plastic polymer is a polyolefin selected from polypropylene and/or polyethylene.

8. An article according to claim 1, wherein the article is in the form of a film and wherein the plastic polymer has a melt flow index of less than 5.0.

9. An article according to claim 1, wherein the solid plastic article comprises from 10 wt % to 60 wt % filler selected from calcium carbonate, calcium sulphate, calcium silicate, talc, mica, clay, and any combination thereof.

10. An article according to claim 1, wherein the titanium dioxide is selected from type 1 plastic titanium dioxide, type 2 plastic titanium dioxide and/or type 3 plastic titanium dioxide.

11. An article according to claim 1, wherein the fly ash comprises less than 1.5 wt % carbon content.

12. An article according to claim 1, wherein the fly ash has a particle size distribution such that the d₅₀ is in the range of from 0.1 μm to 4.0 μm.

13. An article according claim 1, wherein the article has a moisture content of less than 2.0 wt %.

14. An article according to claim 1, wherein the article further comprises an ingredient selected from: coloured pigment; coloured dye;
plasticizer; UV-stabilizer; anti-block agent; anti-oxidant; lubricant; and any combination thereof.

15. An article according to claim 1, wherein the article forms a layer of a laminated film.

16. A process of making a solid plastic article according to claim 1 wherein the process comprises the steps:
(a) obtaining a solid plastic concentrate, wherein the concentrate comprises:
(i) from greater than 5.0 wt % to 55 wt % plastic polymer;
(ii) from 30 wt % to 75 wt % titanium dioxide; and
(iii) from 5.0 wt % to 50 wt % fly ash,
(b) contacting the concentrate with plastic polymer in amounts such that the weight ratio of plastic polymer to concentrate is in the range of from 1:1 to 50:1 to form a mixture;
(c) melting the mixture to form a molten mixture; and
(d) forming and solidifying the molten mixture into a solid plastic article.

17. A process according to claim 16, wherein step (d) is selected from: a blown extrusion step; a cast extrusion step; an injection molding step; a rotary molding step;
and/or a continuous extruded step.

18. A solid plastic concentrate, wherein the concentrate comprises:
(i) from greater than 5.0 wt % to 55 wt % plastic polymer;
(ii) from 30 wt % to 75 wt % titanium dioxide; and
(iii) from 5.0 wt % to 50 wt % fly ash.

19. A concentrate according to claim 18, wherein the plastic polymer is selected from polyolefin, terephthalate polymer, polycarbonate, polystyrene, and polyvinyl chloride.

20. A concentrate according to claim 18, wherein the plastic polymer is a polyolefin selected from polypropylene and polyethylene.
